(19) United States
(12) Patent Application Publication
(10) Pub. No.: US 2021/0397804 A1
(43) Pub. Date: Dec. 23, 2021

(54) DRIVING DEVICE FOR DRIVING TOUCH DISPLAY PANEL WITH FINGERPRINT SENSING FUNCTION AND DRIVING METHOD FOR TOUCH DISPLAY PANEL

(71) Applicant: Novatek Microelectronics Corp., Hsinchu (TW)

(72) Inventors: Yi-Cheng Lin, New Taipei City (TW); Yueh-Teng Mai, Hsinchu City (TW); Jiun-Jie Tsai, Hsinchu County (TW)

(73) Assignee: Novatek Microelectronics Corp., Hsinchu (TW)

(21) Appl. No.: 17/349,948

(22) Filed: Jun. 17, 2021

Related U.S. Application Data
(60) Provisional application No. 63/039,997, filed on Jun. 17, 2020.

(51) Int. Cl. G06K 9/00; G06F 3/041; G06F 3/044

(52) U.S. Cl. CPC G06K 9/0002; G06F 3/044; G06F 3/0416

(57) ABSTRACT

A driving device for driving a touch display panel with fingerprint sensing function and a driving method therefore are provided. The circuit includes a plurality of touch sensing input terminals, a plurality of fingerprint sensing input terminals, a first touch sensing circuit, a fingerprint sensing circuit, and a second touch sensing circuit. The second touch sensing circuit is coupled to a plurality of second touch sensing electrodes in a fingerprint sensor array of the touch display panel through at least a part of the plurality of fingerprint sensing input terminals. The second touch sensing circuit is configured to perform the second touch sensing operation according to the second touch sensing electrodes in the fingerprint sensor array for compensating a touch sensing result of the first touch sensing operation by the first touch sensing circuit.

### CROSS-REFERENCE TO RELATED APPLICATION

This application claims the priority benefit of U.S. provisional application Ser. No. 63/039,997, filed on Jun. 17, 2020. The entirety of the above-mentioned patent application is hereby incorporated by reference herein and made a part of this specification.

### BACKGROUND

### Technical Field

The present disclosure generally relates to a technology for integrating touch sensing operation and fingerprint sensing operation into a touch display panel, and more particularly to a driving device for driving a touch display panel with fingerprint sensing function and a driving method for driving the touch display panel with fingerprint sensing function.

### Description of Related Art

Electronic devices may use touch display panels with both display and touch functions. With the development of technology, it is desired that electronic devices may have a fingerprint recognition function (i.e., fingerprint sensing function). Therefore, many panel manufacturers are developing how to embed the fingerprint sensor into the touch display panel so that the touch display panel has a fingerprint sensing function. There are many ways to implement the fingerprint sensing function, such as capacitive, optical, ultrasonic fingerprint sensing technology...etc. The technology for the touch display panel has advanced to an optical fingerprint sensor embedded in the structure of the touch display panel. The optical fingerprint sensor can be referred to an in-display fingerprint sensor.

However, quality of analog touch sensing signals sensed by in the touch display panel is affected since the fingerprint sensor is embedded in the touch display panel. For example, the fingerprint sensor may occupy part of a conductive layer where the touch sensing electrodes in the touch display panel are formed to make the area of the touch sensing electrodes smaller. Or, the fingerprint sensor and the touch sensing electrode may couple too close with each other so that the signals in these devices are interfered with each other. As a result, the signal strength of touch sensing signals in the touch display panel becomes smaller, which reduces the sensitivity of touch sensing.

### SUMMARY

Accordingly, one or more embodiments of the disclosure provide a driving device for driving a touch display panel with fingerprint sensing function and a driving method for driving the touch display panel with fingerprint sensing function, a part of circuitry of the fingerprint sensor array in the embodiments of the disclosure is also used as the touch sensing electrodes in the touch sensing period for compensating the touch sensing result of first touch sensing operation, so as to improve the touch sensing accuracy of the touch display panel with fingerprint sensing function.

The present disclosure provides a driving device for driving a touch display panel with fingerprint sensing function. The driving device includes a plurality of touch sensing input terminals, a plurality of fingerprint sensing input terminals, a first touch sensing circuit, a fingerprint sensing circuit, and a second touch sensing circuit. The first touch sensing circuit is coupled to a plurality of first touch sensing electrodes in the touch display panel through the plurality of touch sensing input terminals, and the first touch sensing circuit is configured to perform first touch sensing operation. The fingerprint sensing circuit is coupled to a fingerprint sensor array in the touch display panel through the plurality of fingerprint sensing input terminals, and the fingerprint sensing circuit is configured to perform fingerprint sensing operation, wherein the first touch sensing operation and the fingerprint sensing operation are performed non-overlapping in time. The second touch sensing circuit is coupled to a plurality of second touch sensing electrodes in the fingerprint sensor array of the touch display panel through at least a part of the plurality of fingerprint sensing input terminals. The second touch sensing circuit is configured to perform the second touch sensing operation on the second touch sensing electrodes in the fingerprint sensor array for compensating a touch sensing result of the first touch sensing operation by the first touch sensing circuit.

The present disclosure provides a driving method for a touch panel with fingerprint sensing function. The touch panel includes a plurality of first touch sensing electrodes and a fingerprint sensor array. The driving method includes following steps. First touch sensing operation is performed on the plurality of first touch sensing electrodes in the touch display panel. Fingerprint sensing operation is performed on the fingerprint sensor array in the touch display panel, wherein the first touch sensing operation and the fingerprint sensing operation are performed non-overlapping in time. Second touch sensing operation is performed by a plurality of second touch sensing electrodes in the fingerprint sensor array of the touch display panel, wherein the second touch sensing operation performed on the plurality of second touch sensing electrodes in the fingerprint sensor array is to compensate a touch sensing result of the first touch sensing operation.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a structure diagram of a touch display panel without or with fingerprint sensing function in one embodiment.

FIG. 2 is a block diagram of an electronic device with a touch display panel with fingerprint sensing function in first embodiment of the disclosure.

FIG. 3 is a block diagram of an electronic device 300 with a touch display panel with fingerprint sensing function in second embodiment of the disclosure.

FIG. 4 is a schematic diagram of the touch display panel, the switching circuit of the driving device, and some circuits in the second touch sensing circuit in first embodiment of the disclosure.

FIG. 5 is a circuit diagram of part of the fingerprint sensor array in the touch display panel in the first embodiment of the disclosure.

FIG. 6 is a circuit diagram for the front-end circuit of the second touch sensing circuit in FIG. 4 in the first embodiment of the disclosure.

FIG. 7A to 7C are block diagrams for different structures of the driving device 210 of FIG. 4 in the first embodiment of the disclosure.

FIG. 8 is a schematic diagram for presenting a scan direction of the first touch sensing operation and a scan direction of the second touch sensing operation in the touch display panel in the implementation of the disclosed embodiments.

FIG. 9A to 9C are schematic diagrams of the first touch sensing operation by the first touch sensing circuit and the second touch sensing operation by the second sensing circuit for further description of FIG. 8 in the embodiments of the disclosure.

FIG. 10 is a schematic diagram for presenting area of fingerprint sensor array arranged in the touch display panels as examples in the embodiments of the disclosure.

FIG. 11 is a flow diagram of the driving method for a touch panel with fingerprint sensing function in the embodiment of the disclosure.

### DESCRIPTION OF THE EMBODIMENTS

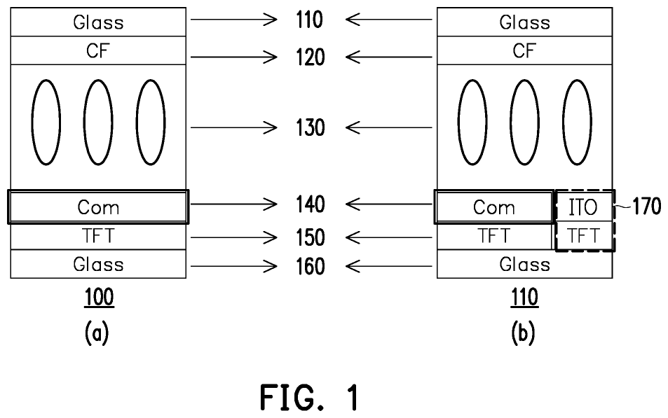

FIG. 1 is a structure diagram of a touch display panel without or with fingerprint sensing function in one embodiment. Part (a) in left side of FIG. 1 shows a touch display panel 100 without fingerprint sensing function, and part (b) in right side of FIG. 1 shows a touch display panel 110 with fingerprint sensing function. Part (a) and part (b) depict the stack structure in view of a unit pixel. The touch display panel 100 and the touch display panel 110, all have glass substrates 110 and 160, color filter layers 120, liquid crystal layers 130, common electrode layers (Com) 140 may be formed by an indium tin oxide (ITO) layer and provide a display common voltage, and thin-film transistor (TFT) layer 150. The common electrode layers 140 may also serves as touch sensing electrode layers 140 where a plurality of touch sensing electrodes are formed. Difference between the touch display panel 100 and 110 is that the touch display panel 110 has a fingerprint sensor circuit 170 formed by the ITO layer and the TFT layer 150 for optically sensing fingerprint touched on the glass substrates 110. In part (b) of FIG. 1, the fingerprint sensor circuit 170 occupies a part of area of the common electrode layers 140 and a part of the TFT layer 150 in the touch display panel 110, thus the signal strength of touch sensing signal obtained by the touch sensing electrodes of the touch display panel 110 is reduced and the sensitivity for touch sensing operation is affected. Besides, the signals from the touch sensing electrodes and from the fingerprint sensor circuit 170 are easy to interfere with each other due to parasitic capacitances or other factors. In other embodiments, the touch sensing electrodes and the fingerprint sensor circuit 170 may not be arranged in the same layer, but in adjacent upper and lower layers. Thus, it still decrease the sensitivity of touch sensing operation due to signal interference. Therefore, it is considered that how to maintain or improve the touch sensing sensitivity of the touch display panel with the fingerprint sensing function in the embodiments of the present disclosure.

In the embodiments of the disclosure, because the electronic device performs the touch sensing operation and the fingerprint sensing operation at different times, and the fingerprint sensor array is implemented as a plurality of fingerprint sensor circuits, some conductive circuitry in the fingerprint sensor circuits may be used as touch sensing electrodes for auxiliary use. Therefore, in the touch sensing operation of the present disclosure, in addition to the touch sensing operation (also referring as the first touch sensing operation) that is performed on the original main touch sensing electrodes (also referring as first touch sensing electrodes), a second touch sensing operation on the conductive circuitry of the fingerprint sensor array acted as the auxiliary touch sensing electrodes (also referring as the second touch sensing electrodes) is also performed, and the sensing results of the aforementioned two touch sensing operations are merged with each other, so as to be the basis for determining the touch position of the touch sensing operation. In other words, some areas of the conductive circuitry in the fingerprint sensor array 224 can be used as the second touch sensing electrodes in addition to the first touch sensing electrodes, thus the sensing results of the first touch sensing operation performed on the first touch sensing electrodes may be compensated by the sensing results of the second touch sensing operation performed on the second touch sensing electrodes in the embodiment of the disclosure, thereby the sensitivity of touch sensing operation is improved. According to the driving device 210 disclosed in the disclosure, a display driving operation, the touch sensing operation (including the first and the second touch sensing operation), and the fingerprint sensing operation are driven in different time period. For example, the display driving operation and the touch sensing operation are operated in different time period. The touch sensing operation and the fingerprint sensing operation are also operated in different time period. The fingerprint sensing operation and the display driving operation may be operated simultaneously or in different time period.

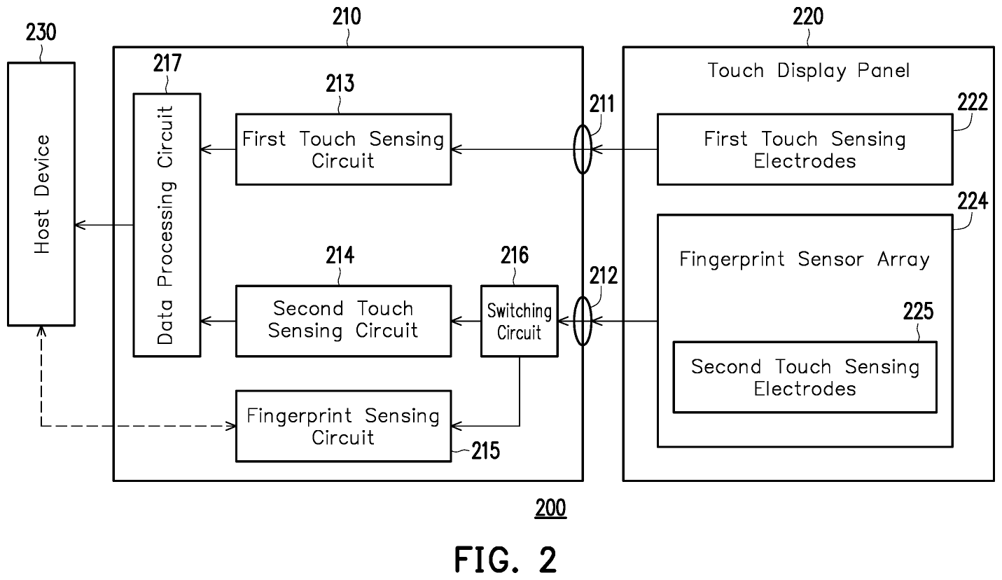

FIG. 2 is a block diagram of an electronic device 200 with a touch display panel with fingerprint sensing function in first embodiment of the disclosure. The electronic device 200 mainly includes a driving circuit 210 and a touch display panel 220. The driving circuit 210 is configured to driving the touch display panel 220. The driving circuit 210 mainly includes a plurality of touch sensing input terminals 211, a plurality of fingerprint sensing input terminals 212, a first touch sensing circuit 213, a second sensing circuit 214, and a fingerprint sensing circuit 215. The touch display panel 220 includes a plurality of first touch sensing electrodes 222 and a fingerprint sensor array 224. The fingerprint sensor array 224 of the embodiment may be arranged in a specific area of the touch display panel 220 according to requirements, or evenly arranged on all areas of the touch display panel 220.

The first touch sensing circuit 213 is coupled to a plurality of first touch sensing electrodes 222 in the touch display panel 220 through the plurality of touch sensing input terminals 211, and the first touch sensing circuit 213 is configured to perform the first touch sensing operation. The fingerprint sensing circuit 215 is coupled to the fingerprint sensor array 224 in the touch display panel through the plurality of fingerprint sensing input terminals 212, and configured to perform fingerprint sensing operation. The fingerprint sensing circuit 215 is connected to the fingerprint sensor array 224 in the touch display panel 220 to readout analog fingerprint sensing signal and convert it into a digital fingerprint sensing data for performing the fingerprint recognition and user identity authentication. In the embodiment of the disclosure, the touch sensing operation by the first touch sensing circuit 213 and the second touch sensing circuit 214 and the fingerprint sensing operation by the fingerprint sensing circuit 215 are performed non-overlapping in time.

In the embodiment of the disclosure, the fingerprint sensor array 224 includes a plurality of second touch sensing electrodes 225, which are formed by a part of conductive circuity of the fingerprint sensor array 224. The second touch sensing circuit 214 is coupled to the plurality of second touch sensing electrodes 225 in the fingerprint sensor array 224 of the touch display panel 220 through at least a part of the plurality of fingerprint sensing input terminals 212. The second touch sensing circuit 214 is configured to perform the second touch sensing operation on the second touch sensing electrodes 225 in the fingerprint sensor array 224 for compensating a touch sensing result of the first touch sensing operation by the first touch sensing circuit 213.

In detail, conductive circuitry of the fingerprint sensor array 224 in the touch display panel 220 may be used as auxiliary touch sensing electrodes (which is also referred as, second touch sensing electrodes 225) in the embodiment of the disclosure to performing the touch sensing operation, and the sensing result of the second touch sensing operation by the second touch sensing circuit 214 may be used to compensate the touch sensing result of the first touch sensing operation by the first touch sensing circuit 213, so as to improve or maintain the touch sensitivity of the electronic circuit 200. In other words, the sensing result of the first touch sensing operation performed by the first touch sensing circuit 213 and the sensing result of the second touch sensing operation performed by the second touch sensing circuit 214 may be merged together to determine the touch position of a finger touch on the touch display panel 220.

The driving circuit 210 further includes a switching circuit 216 and a data processing circuit 217. The switching circuit 216 is coupled to the fingerprint sensing circuit 215 and the second touch sensing circuit 214. The switching circuit 216 is configured to connect the second touch sensing circuit 214 and the at least a part of the plurality of fingerprint sensing terminals 212 in response to the first touch sensing circuit 213 performing the first touch sensing operation, and the switching circuit 216 is further configured to disconnect the second touch sensing circuit 214 and the at least a part of the plurality of fingerprint sensing terminals 212 in response to the fingerprint sensing circuit 215 performing the fingerprint sensing operation. In the embodiments of the disclosure, the fingerprint sensor array 224 may be placed in a large area, similar to the active area of the touch display panel 220, but only a small area of the touch display panel 220 has low touch sensitivity. Therefore, the second touch sensing circuit 214 may receive the second touch sensing signals from the second touch sensing electrodes 225 which are formed by only a part of the conductive circuitry in the fingerprint sensor array 224 corresponding to the area of low touch sensitivity, through a part of the plurality of fingerprint sensing terminals 212.

The data processing circuit 217 is configured to generate a merged touch sensing data according to a first touch sensing data and a second touch sensing data. The first touch sensing data is originated from a first touch sensing signal received by the first touch sensing circuit 213, and the second touch sensing data is originated from a second touch sensing signal received by the second touch sensing circuit 214. The data processing circuit 217 is further configured to determine the touch position according to a plurality of touch sensing data including the merged touch sensing data.

The electronic device 200 further includes a host device 230. The host device 230 may be an application processor (AP) of the electronic device 200. The data processing circuit 217 provides the determined touch position to the host device 230 In some embodiments of the disclosure, in the situation that the user may touch the touch display panel 220 for fingerprint recognition, the host device 230 may receive the determined touch position from the data processing circuit 217 and then provides control information regarding to a range of fingerprint sensing lines which the fingerprint sensing circuit 215 receive sensing signals from, to the fingerprint sensing circuit 215. The control information is generated based on the determined touch position.

The driving device 210 has the first touch sensing circuit 213 and the second touch sensing circuit 214, and the second touch sensing circuit 214 processes the second touch sensing signal from part of the fingerprint sensor array 224 as the second sensing electrodes 225 in the touch display panel 220. The second touch sensing circuit 214 is connected to the corresponding input/output pad in the driving device 210 through the switching circuit 216 to connect to the second sensing electrodes 225.

The touch display panel 220 may be implemented by the self-capacitive touch sensing mechanism or the mutual capacitive touch sensing mechanism. Taking the self-capacitive touch sensing mechanism as an example, the first touch sensing circuit 213 outputs first touch driving signals to the first touch sensing electrodes 222, and obtains the touch sensing signals from the first touch sensing electrodes 222. Similarly, the second touch sensing circuit 214 outputs second touch driving signals to the second touch sensing electrodes 225, and obtains the second touch sensing signals from the second touch sensing electrodes 225. Taking the mutual capacitive touch sensing mechanism as an example, the first touch sensing circuit 213 outputs the first touch drive signals to other electrodes on the touch display panel 220 that are not the first touch sensing electrodes 222, and obtains the first touch sensing signals from the first touch sensing electrodes 222. The second touch sensing circuit 214 outputs the second touch drive signals to other electrodes on the touch display panel 220 that are not the second touch sensing electrodes 225, and obtains the second touch sensing signals from the second touch sensing electrodes 225. The second touch drive signal and the first touch drive signal may be the same signal, that is, the signal having same frequency, same amplitude, and DC offset signal, or the same frequency and same phase but different amplitude and/or DC offset. The amplitude or DC offset of the two touch drive signals can be adjusted according to the actual conditions of different touch display panels.

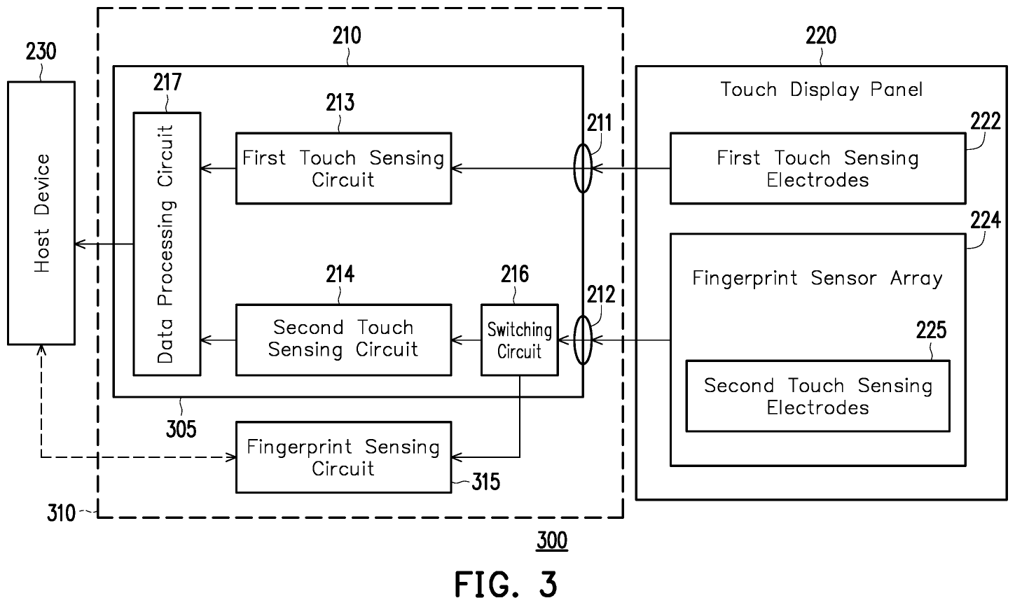

In the embodiment of the disclosure, the driving circuit 210 may be a single chip integrated circuit (i.e., a touch sensing and fingerprint sensing integrated circuit) for merging the touch and display driver integrated circuit (TDDI) and the fingerprint sensing circuit. In the other embodiment of the disclosure, the driving circuit 210 may be referred to two integrated circuits (IC) set separately with the touch and display driver integrated circuit (TDDI) and the fingerprint sensing circuit. FIG. 3 is a block diagram of an electronic device 300 with a touch display panel with fingerprint sensing function in second embodiment of the disclosure. Referring to FIG. 3, the difference between FIG. 2 and FIG. 3 is, the driving device 310 includes two ICs for the touch and display driver integrated circuit 305 and the fingerprint sensing circuit 315. The touch and display driver integrated circuit 305 includes the first and the second touch sensing circuits 213 and 214, the switching circuit 216 and the data processing circuit 217. Each of the units or circuits in the FIG. 2 and FIG. 3 has the same function. In an alternative of the second embodiment, the switching circuit 216 may be placed on a circuity on the touch display panel 220.

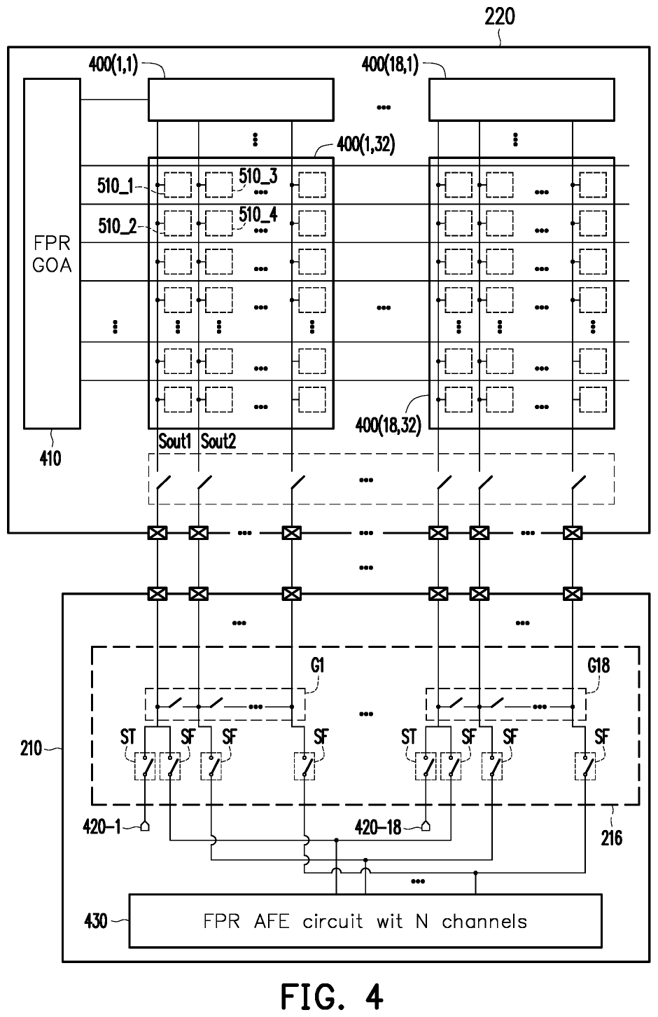

FIG. 4 is a schematic diagram of the touch display panel 220, the switching circuit 216 of the driving device 210, and some circuits in the second touch sensing circuit 214 in first embodiment of the disclosure. Referring to FIG. 4, it's mainly illustrated the fingerprint sensor array 224 and the corresponding circuits in the touch display panel 220 for implementing the embodiment of the disclosure. In the touch display panel 220 of the embodiment, it has the plurality of the first sensing electrodes 400(1, 1) to 400(18, 32) which have 18 rows and 32 columns. Accordingly, the number of the second touch sensing electrode 225 may be 18 at most. It further has a plurality of fingerprint sensors (e.g., fingerprint sensors 510-1-510-4) with 1080 columns of the fingerprint sensor array 224, respectively coupled to 1080 fingerprint sensing lines (denoted as Sout1, Sout2, etc.) in the touch display panel 220 of the embodiment, based on a display resolution of full HD as an example. For example, the fingerprint sensors 510-1-510-2 are connected to a fingerprint sensing line Sout1, the fingerprint sensors 510-3-510-4 are connected to a fingerprint sensing line Sout2, and so on. For example, the conductive circuitry of the fingerprint sensors in the area of the first sensing electrodes 400(1, 32) form a second touch sensing electrode 225. The total 1080 fingerprint sensing lines are connected to 1080 fingerprint sensing input terminals of the driving circuit 210. The first touch sensing circuit 213 may have 32 analog front-end circuits (as referred as AFE channels, not shown in FIG. 4) for touch sensing on the left side of the touch display panel 220 and 32 analog front-end circuits for touch sensing on the right side of the touch display panel 220, and the second touch sensing circuit 214 may have 18 AFE circuits, denoted as 420-1 to 420-18. The second touch sensing circuit 214 may be responsible for processing the second touch sensing signals from a row of the second touch sensing electrodes 225 at the same time.

In FIG. 4, the switching circuit 216 comprises a plurality of switch groups, such as switch group G1 to switch group G18, wherein every switch group includes a plurality of switch elements for short-circuiting a group of fingerprint sensing input terminals such as 60 fingerprint sensing input terminals in response to the first touch sensing circuit 213 performing the first touch sensing operation. By short-circuiting the fingerprint sensing input terminals group by group, the second touch sensing signals on a row of the second touch sensing electrode 225 may be received by the second touch sensing circuit 225 at the same time while the first touch sensing circuit 213 performs the first touch sensing operation. In time period of the first touch sensing operation, the second touch sensing circuit 214 provides the second touch driving signals to the fingerprint sensors and receives the second touch sensing signals row-by-row. In the first touch sensing operation, a plurality of fingerprint sensing input terminals 212, which are corresponding to the fingerprint sensing lines connected to the fingerprint sensors in the area of the first touch sensing electrode such as 400(1,32), are short-circuited to form as one node, and thus the AFE circuit 420-1 of the second touch sensing circuit 214 receives the second sensing signal from the node. In the example of FIG. 4, a switch element ST is placed between each of AFE circuits 420-1 to 420-18 and the respective short-circuited node, and switch element ST are turned on in response to performing the first and the second touch sensing operations.

Besides, the switching circuit 216 further comprises a plurality of switch elements SF, such as 1080 switch elements, wherein each switch element SF is capable of connecting a corresponding fingerprint sensing input terminal to one AFE channel of the fingerprint sensing circuit 215 when performing fingerprint sensing operation. As the mentioned previously, the host device 230 may receive the determined touch position from the data processing circuit 217 and accordingly provides control information with respect to a range of fingerprint sensing lines which the fingerprint sensing circuit 215 receive sensing signals from, to the fingerprint sensing circuit 215. In time period of the fingerprint sensing operation, some of the plurality of the switch elements SF are turned according to the control information to connect a part of the fingerprint sensing input terminals, which are connected to the fingerprint sensing lines in the range determined based on the determined touch position, to corresponding AFE channels of the fingerprint AFE circuit 430. In time period of the fingerprint sensing operation, the switch groups G1 to G18 are turned off.

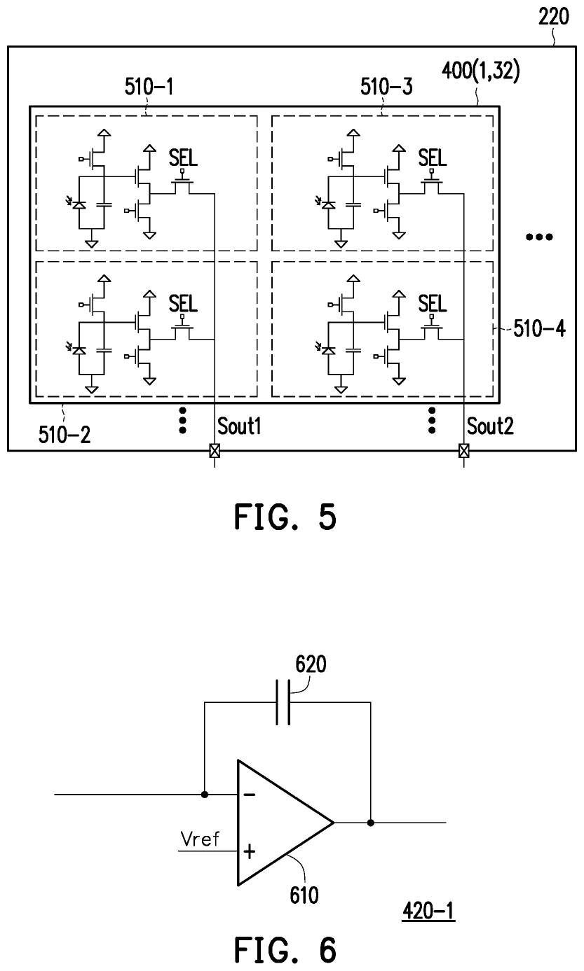

Further details for circuit structure of the fingerprint sensors (e.g., the fingerprint sensors 510-1-510-4) are referred to an example in FIG. 5. FIG. 5 is a circuit diagram of part of the fingerprint sensor array 224 in the touch display panel 220 in the first embodiment of the disclosure. FIG. 5 takes a second touch sensing electrode corresponding to an area of 2×2 fingerprint sensors 510-1-510-4 as an example, and the real second touch sensing electrode in the touch display panel 220 may correspond to 50×50 fingerprint sensing pixels or more.

As shown in FIG. 5, each circuit structure of the fingerprint sensors 510-1-510-4 has a plurality of transistors, for example, a select transistor SEL, a reset transistor and a bypass transistor. The conductive circuitry of the fingerprint sensors 510-1-510-4 is in the same layer as the first touch sensing electrode 222. It is supposed that the fingerprint sensors 510-1-510-4 are in a sensing range determined by the touch position. During the time period of the fingerprint sensing operation, the fingerprint sensing lines Sout1 and Sout2 are electrically connected through the switching circuit 216 in FIGS. 2 and 4. In time period of the fingerprint sensing operation, the fingerprint gate-on-array (FPR GOA) circuit 410 provides scanning signals, such as gate control signals SEL in FIG. 5, row by row to each fingerprint sensor row in the determined sensing range.

During the time period of the touch sensing operation, the fingerprint sensing circuit 215 in FIG. 2 sends a control signal to the FPR GOA circuit 410, and the FPR GOA circuit 410 generates a gate control signal (SEL) to turn on/off a select transistor SEL of the fingerprint sensors 510-1-510-4 according to the control signal transmitted by the fingerprint sensing circuit 215. To realize the second touch sensing operation, the select transistors SEL in the area of the second touch sensing electrode 400(1,32) are turned on at the same time. Thus, the second touch driving signals can be transmitted through the fingerprint sensing lines Sout1 and Sout2 to the drain terminals of the select transistors SEL, and the second touch driving signals are coupled to other conductive lines in the fingerprint sensors, such as gate terminal of a bypass transistor in each fingerprint sensor, from the drain terminal of the select transistors SEL due to the capacitive coupling effect.. The gate terminal of a bypass transistor in each fingerprint sensors of FIG. 5 is coupled to a capacitor and an anode of a photosensitive element. In this way, the conductive circuitry in the fingerprint sensors in the same layer of the first touch sensing electrode 222 in FIG. 2 is used as the second touch sensing electrodes 225, and the second touch sensing signal generated by the second touch sensing electrodes 225 can compensate for signal loss of the first touch sensing electrodes 222 in FIG. 2.

FIG. 6 is a circuit diagram for the AFE circuit 420-1 of the second touch sensing circuit 214 in FIG. 4 in the first embodiment of the disclosure. The AFE circuit 420-1 of the second touch sensing circuit 214 in FIG. 4 includes an amplifier 610 and a feedback capacitor 620. The feedback capacitor 620 is coupled between an inverting terminal and an output terminal of the amplifier 610. In this case, a non-inverting terminal of the amplifier 610 is coupled to a reference voltage source Vref which provides the second touch driving signal. The inverting terminal of the amplifier 610 is coupled to a second touch sensing electrode and thus receive a second touch sensing signal when performing the second touch sensing operation. The output terminal of the amplifier 610 is connected to other part (not shown) of circuitry of the AFE circuit 420-1.

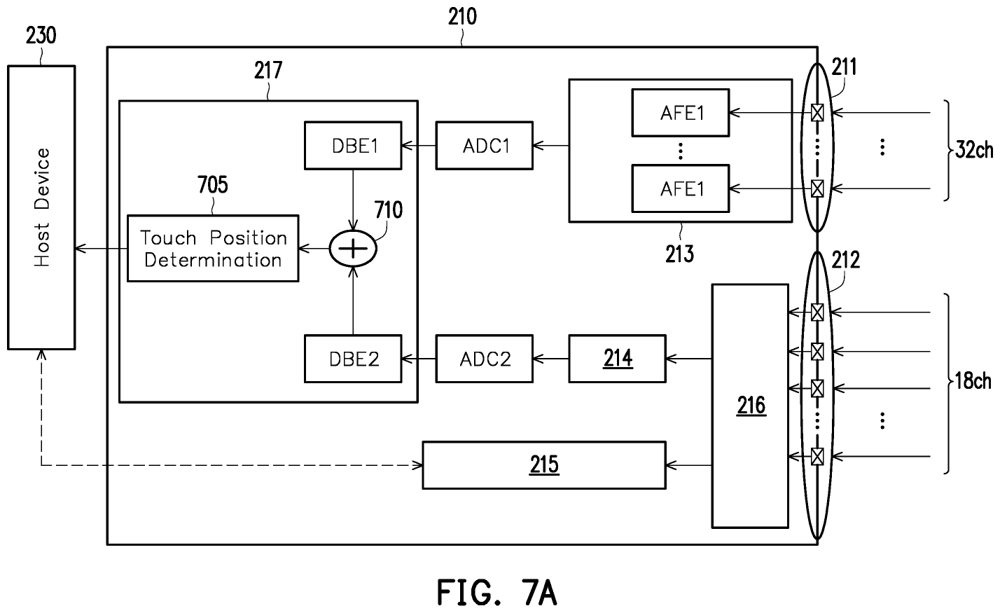

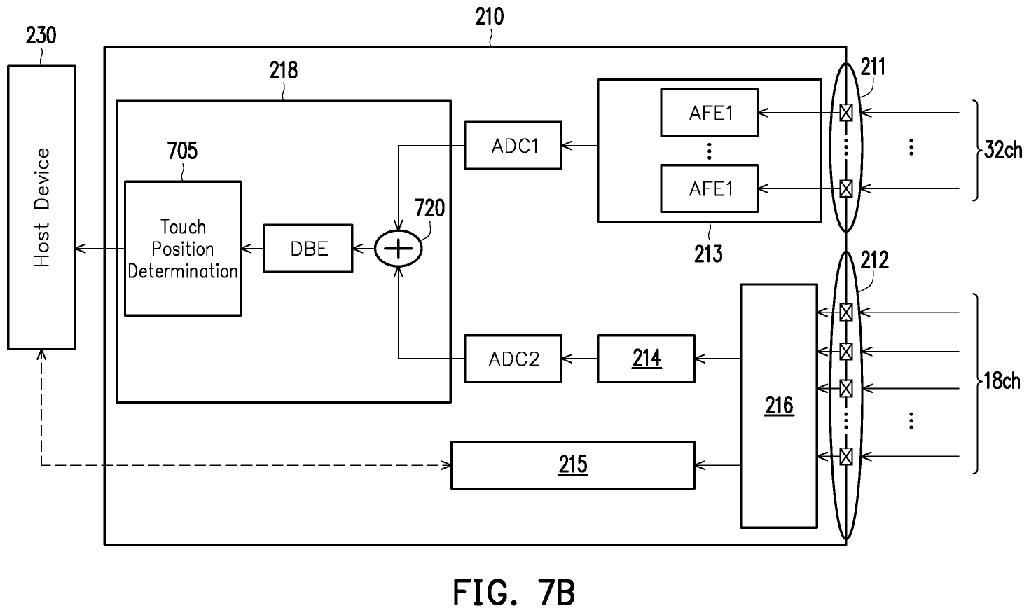

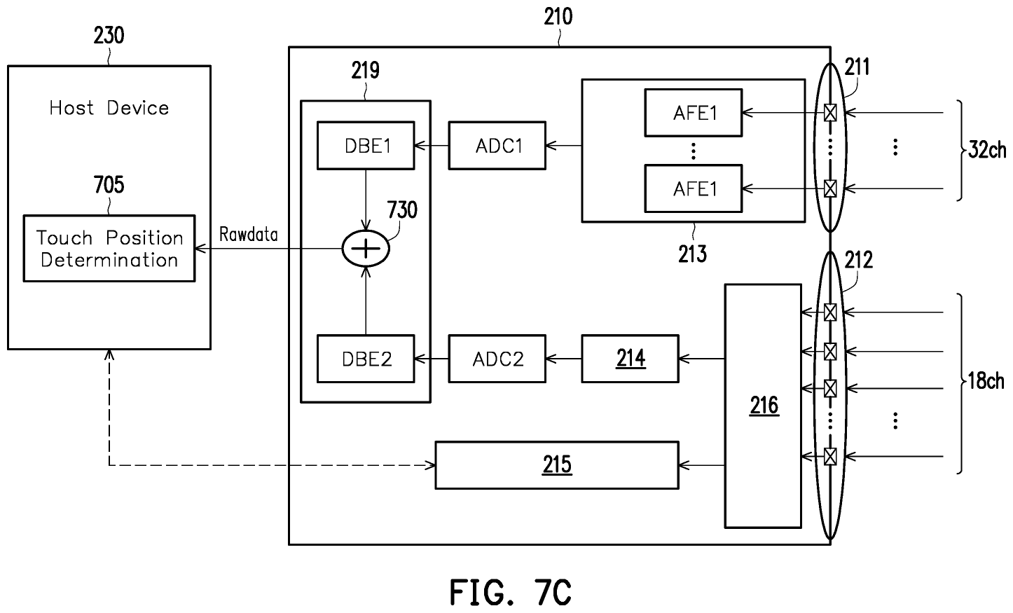

FIG. 7A to 7C are block diagrams for different structures of the driving device 210 of FIG. 4 in the first embodiment of the disclosure. In FIG. 7A, the driving device 210 further includes a first analog-to-digital converter (ADC) ADC1 coupled between the data processing circuit 217 and the first touch sensing circuit 213 and a second ADC ADC2 coupled between the data processing circuit 217 to the second touch sensing circuit 214. The first touch sensing circuit 213 includes a plurality of AFE circuits AFE1, and each of first AFE circuits (also referred as AFE channels) AFE1 is configured to receive and process an analog first touch sensing signal from one of the first touch sensing electrodes through one of the plurality of touch sensing input terminals 211. In the embodiment, the first touch sensing circuit 213 and the second touch sensing circuit 214 are having 18 channels. The second touch sensing circuit 214 may also include a plurality of second AFE circuits, and each of the second analog front-end circuits AFE2 is configured to receive and process an analog second touch sensing signal from one of the second touch sensing electrodes through a part of the plurality of fingerprint sensing input terminals 212.

In FIG. 7A, the data processing circuit 217 of the driving device 210 includes digital back-end processing circuits DBE1 and DBE2, an adder circuit 710, and a touch position determination circuit 705. The analog first touch sensing signal is sensed and received by the first touch sensing circuit 213, and the analog first touch sensing signal is converted by the ADC ADC1 to generate a digital first touch sensing data. The digital back-end processing circuit DBE1 receives and processes the digital first touch sensing data to generate the first touch sensing data. The analog second touch sensing signal is sensed and received by the second touch sensing circuit 214, and the analog second touch sensing signal is converted by the ADC ADC2 to generate a digital second touch sensing data. The digital back-end processing circuit DBE2 receives and processes the digital second touch sensing data to generate the second touch sensing data. In other words, the first touch sensing data is originated from the first touch sensing signal received by the first touch sensing circuit 213, and the second touch sensing data is originated from the second touch sensing signal received by the second touch sensing circuit 214. The adder circuit 710 generate a merged touch sensing data according a first touch sensing data and a second touch sensing data. The touch position determination circuit 705 determines a touch position according to the plurality of touch sensing data including the merged touch sensing data generated by the adder circuit 710.

It is noticed that, the first touch sensing signal is sensed and received by the first touch sensing circuit 213 in the sensing position of the touch display panel 220, and the second touch sensing signal is sensed and received by the second touch sensing circuit 214 in the same sensing position of the touch display panel 220. The driving device 210 further includes a memory unit coupled to the data processing circuit. The memory unit temperately stores the first touch sensing data and the second touch sensing data, and the adder circuit 710 of the data processing circuit 217 accesses the memory unit to obtain the first touch sensing data and the second touch sensing data for generating the merged touch sensing data.

In FIG. 7B, a data processing circuit 218 of the driving device 210 includes an adder circuit 720, a digital back-end processing circuit DBE, and a touch position determination circuit 705. The adder circuit 720 generate a digital merged touch sensing data according a first touch sensing data from the ADC ADC1 and a second touch sensing data from the ADC ADC2. The digital back-end processing circuit DBE receives and processes the digital merged touch sensing data to generate the merged touch sensing data. The touch position determination circuit 705 determines a touch position according to the plurality of touch sensing data including the merged touch sensing data generated by the digital back-end processing circuit DBE.

In FIG. 7C, a data processing circuit 219 of the driving device 210 includes an adder circuit 730 and digital back-end processing circuits DBE1 and DBE2. The analog first touch sensing signal is sensed and received by the first touch sensing circuit 213, and the analog first touch sensing signal is converted by the ADC ADC1 to generate a digital first touch sensing data. The digital back-end processing circuit DBE1 receives and processes the digital first touch sensing data to generate the first touch sensing data. The analog second touch sensing signal is sensed and received by the second touch sensing circuit 214, and the analog second touch sensing signal is converted by the ADC ADC2 to generate a digital second touch sensing data. The digital back-end processing circuit DBE2 receives and processes the digital second touch sensing data to generate the second touch sensing data. The adder circuit 730 generate a merged touch sensing data in a rawdata form according a first touch sensing data and a second touch sensing data. In detail, the first touch sensing data and the second touch sensing data are also in the rawdata form, thus the adder circuit 730 generate a merged touch sensing data for adding the first touch sensing data and the second touch sensing data directly in the rawdata form. The data processing circuit 219 transmits the merged touch sensing data to the host device 230 The host device 230 further includes a touch position determination circuit 706 for determining a touch position according to the plurality of touch sensing data including the merged touch sensing data in the rawdata form.

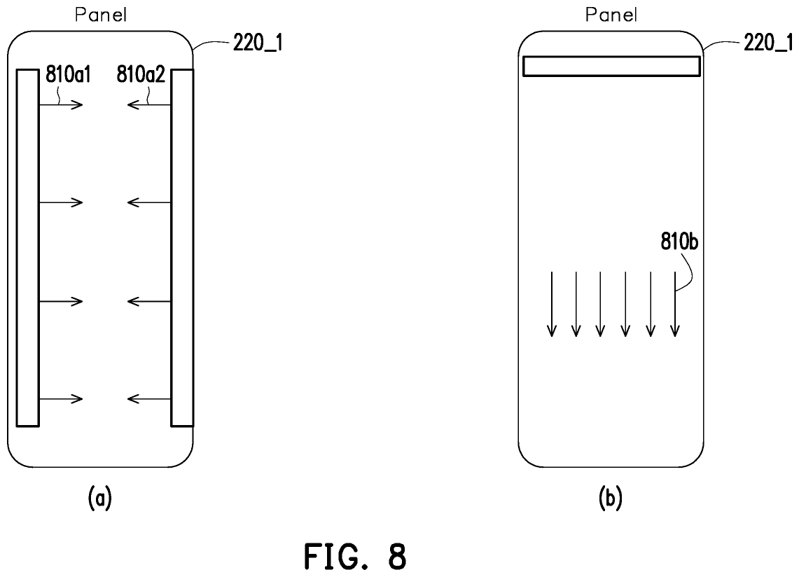

In the implementation of the disclosure embodiments, the scan direction of the first touch sensing operation on the first touch sensing electrodes is different from the scan direction of the second fingerprint sensing operation on the second touch sensing electrodes. FIG. 8 is a schematic diagram for presenting a scan direction of the first touch sensing operation and a scan direction of the second touch sensing operation in the touch display panel in the implementation of the disclosed embodiments. In detail, part (a) of FIG. 8 presents that the first touch sensing circuit 213 in FIG. 2 receives the first touch sensing signals from two columns of the first touch sensing electrodes on the touch display panel 220_1 at the same time, and the scan directions 810a1 and 810a2 indicate the next positions of two columns of the first touch sensing electrodes at next time period of the first touch sensing operation. The first touch sensing operation is performed by scanning the first touch sensing electrodes from the left side toward the center in the horizontal direction (the scan direction 810a1) and from right side toward the center in the horizontal direction (the scan direction 810a2). Part (b) of FIG. 8 presents that the second touch sensing circuit 214 receives the second touch sensing signals from one row of the second touch sensing electrodes on the touch display panel 220_1 at the same time, and the scan direction 810b of the second touch sensing circuit 214 indicates the next positions of one row of the second touch sensing electrodes at next time period of the second touch sensing operation. Because the first touch sensing operation and the second touch sensing operation has different scan direction, some second touch sensing data are required to be saved in the memory unit.

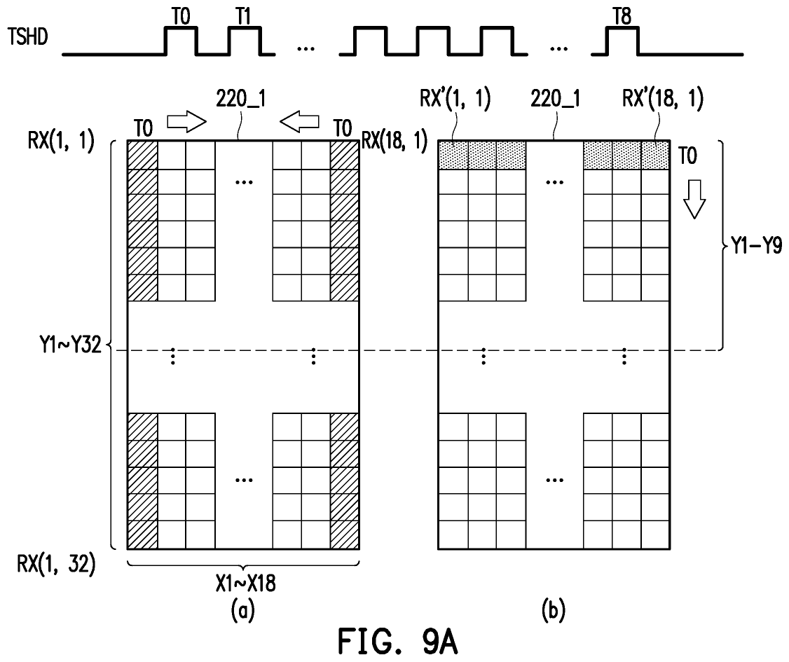

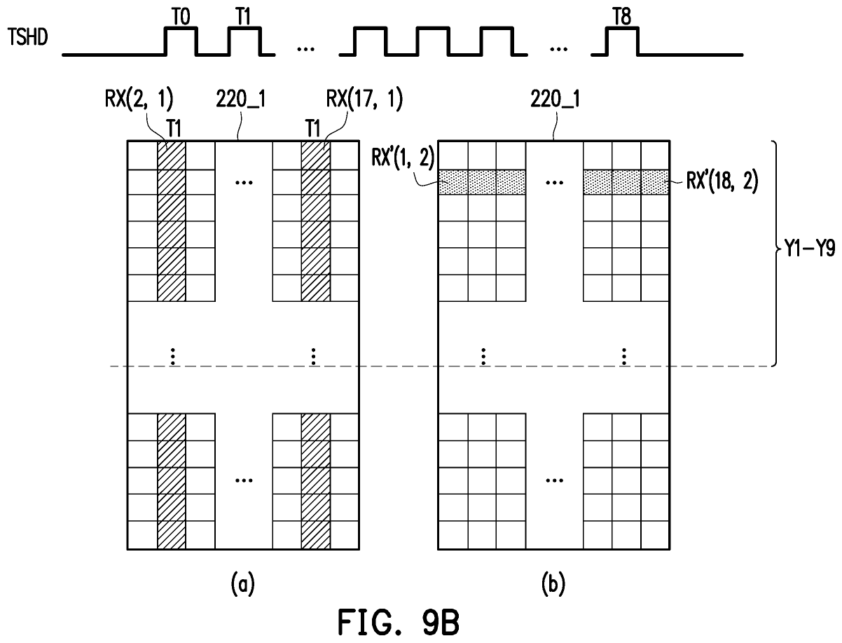

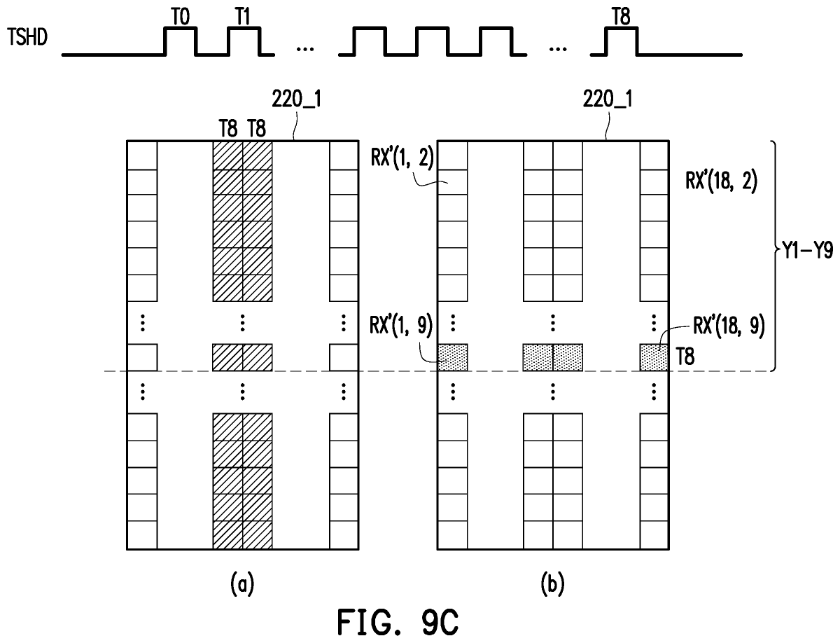

FIG. 9A to 9C are schematic diagrams of the touch sensing operation by the first touch sensing circuit and the second touch sensing circuit for further description of FIG. 8 in the embodiments of the disclosure. There is a touch sensing enable signal TSHD with periodic pulses sequentially in time periods denoted by T0-T8 in which the first and the second touch sensing operations are performed. FIGS. 9A-9C presents the situation for receiving the first touch sensing data by the first touch sensing circuit 213 and receiving the second touch sensing data by the second touch sensing circuit 214 at the time periods T0, T1, and T8. In the disclosed embodiment, the touch display panel 220_1 has 18 columns X1˜X18 and 32 rows Y1˜Y32 of the first touch sensing electrodes, and the first touch sensing data are denoted by RX(1, 1) to RX(18, 32) and the second touch sensing data are denoted by RX′(1, 1) to RX′(18, 9) in rows Y1-Y9. In other words, the second touch sensing electrodes is only arranged in rows Y1-Y9, and there are no second touch sensing electrodes in rows Y10-Y18. The first touch sensing data RX(1, 1) and the second touch sensing data RX′(1, 1) are sensed at the same sensing position of the touch display panel.

In FIG. 9A at time period T0, the first touch sensing data of each first touch sensing electrode at the columns X1 and X18 are received at the same time in part (a) of FIG. 9A, and the second touch sensing data of each second touch sensing electrode at the row Y1 are received at the same time in part (b) of FIG. 9A. Thus, the merged touch sensing data corresponding to the position of the first touch sensing electrode (X1,Y1) may be generated based on the first touch sensing data RX(1, 1) and the second touch sensing data RX′(1, 1), and the merged touch sensing data corresponding to the position of the first touch sensing electrode (X18,Y1) may be generated based on the first touch sensing data RX(18, 1) and the second touch sensing data RX′(18, 1), but the other touch sensing data in the time period T0 (i.e., RX(1, 2) to RX(1, 9), RX′(2, 1) to RX′(17, 1)) needs to temperately stored by the memory unit.

In FIG. 9B at the time period T1, the first touch sensing data of each first touch sensing electrode at the columns X2 and X17 are received at the same time in part (a) of FIG. 9B, and the second touch sensing data of each second touch sensing electrode at the row Y2 are received at the same time in part (b) of FIG. 9B. Thus, the merged touch sensing data corresponding to the position of the first touch sensing electrode (X2, Y1) may be generated based on the first touch sensing data RX(2, 1) and the previously stored second touch sensing data RX′(2, 1), and the merged touch sensing data corresponding to the position of the first touch sensing electrode (X17, Y1) may be generated based on the first touch sensing data RX(17, 1) and the previously stored second touch sensing data RX′(17, 1). The merged touch sensing data corresponding to the position of the first touch sensing electrode (X2, Y2) may be generated based on the first touch sensing data RX(2, 2) and the second touch sensing data RX′(2, 2), and the merged touch sensing data corresponding to the position of the first touch sensing electrode (X17, Y2) may be generated based on the first touch sensing data RX(17, 2) and the second touch sensing data RX′ (17, 2). But the other touch sensing data in the time period T1 needs to temperately stored by the memory unit.

In FIG. 9C at the time period T8, the first touch sensing data of each first touch sensing electrode at the columns X9 and X10 are received at the same time in part (a) of FIG. 9C, and the second touch sensing data of each second touch sensing electrode at the row Y9 are received at the same time in part (b) of FIG. 9C. How the merged touch sensing data are generated can be referred to the description of FIGS. 9A and 9B

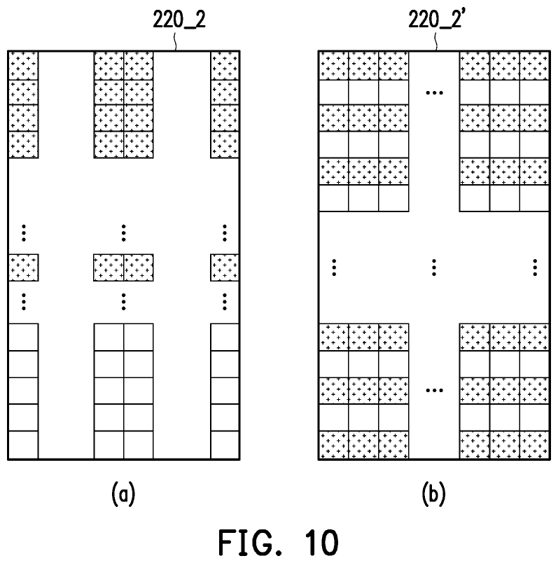

FIG. 10 is a schematic diagram for presenting area of fingerprint sensor array arranged in the touch display panels 220_2, 220_2′ as examples in the embodiments of the disclosure. In part (a) of the touch display panel 220_2, the second touch sensing electrodes are only arranged in rows Y1-Y9, and there are no second touch sensing electrodes in rows Y10-Y18. In part (b) of the touch display panel 220_2, the second touch sensing electrodes are arranged on all areas of the touch display panel 220_2′ with interval arrangement of a row in the touch display panel 220_2′. Those skilled in the art may adjust sensing positions of the second touch sensing electrode in the touch display panel according to their needs.

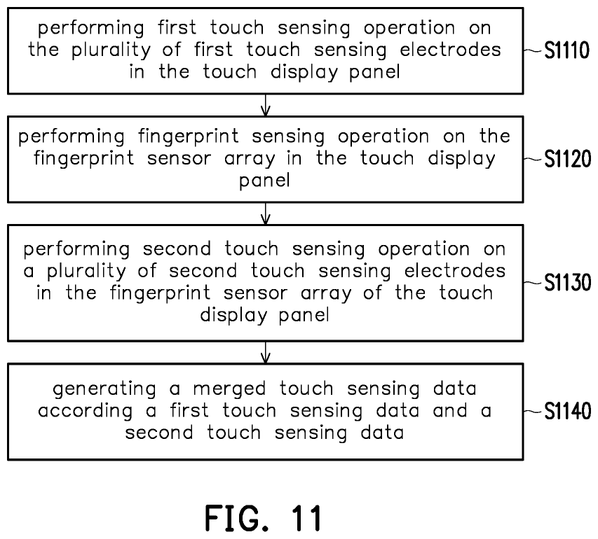

FIG. 11 is a flow diagram of the driving method for a touch panel with fingerprint sensing function in the embodiment of the disclosure. The flow diagram of the driving method in FIG. 11 is implemented with the driving circuit 210 in FIG. 2 or the driving circuit 310 in FIG. The driving method mainly includes steps S1110-S1130. In step S1110, the driving circuit performs a first touch sensing operation by the plurality of first touch sensing electrodes in the touch display panel. In step S1120, the driving circuit performs fingerprint sensing operation by the fingerprint sensor array in the touch display panel, wherein the first touch sensing operation and the fingerprint sensing operation are performed non-overlapping in time. In step S1130, the driving circuit performs a second touch sensing operation by a plurality of second touch sensing electrodes in the fingerprint sensor array of the touch display panel, wherein the second touch sensing operation performed on the plurality of second touch sensing electrodes in the fingerprint sensor array is to compensate a touch sensing result of the first touch sensing operation.

The driving method further includes step S1140. In step S1140, the driving circuit generates a merged touch sensing data according a first touch sensing data and a second touch sensing data, wherein the first touch sensing data is originated from a first touch sensing signal received by the first touch sensing circuit, and the second touch sensing data is originated from a second touch sensing signal received by the second touch sensing circuit. And, the driving circuit determines a touch position according to a plurality of touch sensing data including the merged touch sensing data. The implementation details of the driving method please refer to above embodiments of the disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A driving device for driving a touch display panel with fingerprint sensing function, the driving device comprising:
a plurality of touch sensing input terminals;
a plurality of fingerprint sensing input terminals;
a first touch sensing circuit, coupled to a plurality of first touch sensing electrodes in the touch display panel through the plurality of touch sensing input terminals, and configured to perform a first touch sensing operation;
a fingerprint sensing circuit, coupled to a fingerprint sensor array in the touch display panel through the plurality of fingerprint sensing input terminals, and configured to perform fingerprint sensing operation, wherein the first touch sensing operation and the fingerprint sensing operation are performed non-overlapping in time; and
a second touch sensing circuit, coupled to a plurality of second touch sensing electrodes in the fingerprint sensor array of the touch display panel through at least a part of the plurality of fingerprint sensing input terminals,
wherein the second touch sensing circuit is configured to perform a second touch sensing operation on the second touch sensing electrodes in the fingerprint sensor array for compensating a touch sensing result of the first touch sensing operation by the first touch sensing circuit.

2. The driving device of claim 1, further comprising:
a switching circuit, coupled to the fingerprint sensing circuit and the second touch sensing circuit, configured to connect the second touch sensing circuit and the at least a part of the plurality of fingerprint sensing terminals in response to the first touch sensing circuit performing the first touch sensing operation, and configured to disconnect the second touch sensing circuit and the at least a part of the plurality of fingerprint sensing terminals in response to the fingerprint sensing circuit performing the fingerprint sensing operation.

3. The driving device of claim 2, wherein the switching circuit comprises a plurality of switch groups, and each of the plurality of switch groups comprises a plurality of switch elements configured to short-circuit a first number of fingerprint sensing input terminals in response to the first touch sensing circuit performing the first touch sensing operation.

4. The driving device of claim 2, wherein the switching circuit comprises a plurality of switch elements, and
a preconfigured number of switch elements among the plurality of switch elements are selected to be conducted to transmit fingerprint sensing signals to the fingerprint sensing circuit by the at least a part of the plurality of fingerprint sensing terminals in response to the fingerprint sensing circuit performing fingerprint sensing operation.

5. The driving device of claim 1, further comprising:
a data processing circuit, configured to generate a merged touch sensing data according a first touch sensing data and a second touch sensing data, wherein the first touch sensing data is originated from a first touch sensing signal received by the first touch sensing circuit, and the second touch sensing data is originated from a second touch sensing signal received by the second touch sensing circuit, and
the data processing circuit is further configured to determine a touch position according to a plurality of touch sensing data including the merged touch sensing data.

6. The driving device of claim 5, further comprising:
a memory unit, coupled to the data processing circuit,
wherein the memory unit temperately stores the first touch sensing data and the second touch sensing data, and the data processing circuit accesses the memory unit to obtain the first touch sensing data and the second touch sensing data for generating the merged touch sensing data.

7. The driving device of claim 1, wherein the first touch sensing circuit comprises a plurality of first analog front-end circuits, and each of the first analog front-end circuits is configured to receive and process an analog touch sensing signal from one of the touch sensing electrodes, and
wherein the second touch sensing circuit comprises a plurality of second analog front-end circuits and each of the second analog front-end circuits is configured to receive and process an analog touch sensing signal from one of the second touch sensing electrodes.

8. The driving device of claim 7, wherein first touch sensing data is received by the first touch sensing circuit is with respect to a sensing position of the touch display panel, and the second touch sensing data is received by the second touch sensing circuit is with respect to the same sensing position of the touch display panel.

9. The driving device of claim 5, further comprising:
a first analog-to-digital converter coupled between the data processing circuit and the first touch sensing circuit; and
a second analog-to-digital converter coupled between the data processing circuit to the second touch sensing circuit.

10. The driving device of claim 1, wherein the plurality of second touch sensing electrodes are formed by a part of a circuitry of the fingerprint sensor array and are connected to the at least a part of the plurality of fingerprint sensing input terminals.

11. A driving method for a touch panel with fingerprint sensing function, wherein the touch panel includes a plurality of first touch sensing electrodes and a fingerprint sensor array, the driving method comprising:
performing a first touch sensing operation on the plurality of first touch sensing electrodes in the touch display panel;
performing fingerprint sensing operation on the fingerprint sensor array in the touch display panel, wherein the first touch sensing operation and the fingerprint sensing operation are performed non-overlapping in time; and
performing a second touch sensing operation on a plurality of second touch sensing electrodes in the fingerprint sensor array of the touch display panel, wherein the second touch sensing operation performed on the plurality of second touch sensing electrodes in the fingerprint sensor array is to compensate a touch sensing result of the first touch sensing operation.

12. The driving method of claim 11, wherein the plurality of second touch sensing electrodes are formed by a part of circuitry of the fingerprint sensor array.

13. The driving method of claim 11, wherein the driving method is implemented by a driving device,
wherein the driving device includes a plurality of touch sensing input terminals, a plurality of fingerprint sensing input terminals, a first touch sensing circuit, and a second touch sensing circuit,
the first touch sensing circuit is coupled to the plurality of first touch sensing electrodes in the touch display panel through the plurality of touch sensing input terminals, and the first touch sensing circuit performs the first touch sensing operation,
the second touch sensing circuit is coupled to the plurality of second touch sensing electrodes in the fingerprint sensor array of the touch display panel through at least a part of the plurality of fingerprint sensing input terminals, and the second touch sensing circuit performs the second touch sensing operation according to the plurality of second touch sensing electrodes in the fingerprint sensor array.

14. The driving method of claim 13, wherein the driving device further includes a switching circuit coupled to the fingerprint sensing circuit and the second touch sensing circuit,
the driving method further comprises:
controlling the switching circuit to connect the second touch sensing circuit and the at least a part of the plurality of fingerprint sensing terminals in response to the first touch sensing circuit performing the first touch sensing operation; and
controlling the switching circuit to disconnect the second touch sensing circuit and the at least a part of the plurality of fingerprint sensing terminals in response to the fingerprint sensing circuit performing the fingerprint sensing operation.

15. The driving method of claim 14, wherein the switching circuit comprises a plurality of switch groups, and each of the plurality of switch groups comprises a plurality of switch elements configured to short-circuit a first number of fingerprint sensing input terminals in response to the first touch sensing circuit performing the first touch sensing operation.

16. The driving method of claim 14, wherein the switching circuit comprises a plurality of switch elements, and
a preconfigured number of switch elements among the plurality of switch elements are selected to be conducted to transmit fingerprint sensing signals to the fingerprint sensing circuit by the at least a part of the plurality of fingerprint sensing terminals in response to the performing the fingerprint sensing operation.

17. The driving method of claim 11, further comprising:
generate a merged touch sensing data according a first touch sensing data and a second touch sensing data, wherein the first touch sensing data is originated from a first touch sensing signal received by the first touch sensing circuit, and the second touch sensing data is originated from a second touch sensing signal received by the second touch sensing circuit; and
determining a touch position according to a plurality of touch sensing data including the merged touch sensing data.

18. The driving method of claim 17, wherein the first touch sensing data is sensed and received by the first touch sensing circuit in a sensing position of the touch display panel, and the second touch sensing data is sensed and received by the second touch sensing circuit in the same sensing position of the touch display panel.
